(19) United States
(12) Patent Application Publication
(10) Pub. No.: US 2007/0024578 A1
(43) Pub. Date: Feb. 1, 2007

(54) Portable computing device with integrated mouse function

(75) Inventor: David T. Lundquist, Setauket, NY (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Symbol Techologies, Inc., Holtsville, NY (US)

(21) Appl. No.: 11/193,539

(22) Filed: Jul. 29, 2005

(51) Int. Cl. G09G 5/00

(52) U.S. Cl. 345/156

(57) ABSTRACT

The claimed subject matter provides a system and/or a method that facilitates enhancing navigation associated with a portable computing device. An interface can receive surface data based on a change of positioning related to the portable device. A navigation component can implement navigation within the portable computing device based at least in part upon surface data.

### BACKGROUND

The development and refinement of personal computing devices continues to occur at an extremely rapid pace. Advancements in personal computing devices are mostly based upon consumer demand. In order to fulfill consumer needs, the industry provides a plurality of devices (e.g., models of devices having various applications, and features). Smaller devices, game applications, web access, storage capacity, display size, ergonomics, phonebook storage, longer battery life, are a few examples that encourage the personal computing industry to improve upon existing technology.

Mobile devices are increasing in technological ability wherein personal computing devices can provide a plurality of functionality within a limited device-space. Personal computing devices can be, but not limited to, cell phones, PDA, pagers, tablets, hand-helds, pocket translators, bar code scanners, smart phones, scanners, . . . Although each device employs a specific function for a user, devices have been developing to allow overlapping functionality in order to appeal to consumer needs. In other words, personal computing devices have incorporated a plurality of features and/or applications such that the devices have invaded one another's functionality. For example, cell phones can provide cellular service, phonebooks, calendars, games, voicemail, paging, web browsing, video capture, image capture, voice memos, voice recognition, . . .

As a result, personal computing devices have incorporated a variety of techniques and/or methods for inputting information and/or navigating information. The navigation of information associated with personal computing devices continues to be an issue as such personal computing devices storage capacity and/or functionality increases. For instance, a cell phone was traditionally utilized to make a phone call wherein a numeric keypad was only necessary for such functionality. Yet, cell phones can now provide data input (e.g., address books, calendars, calculators, cameras, etc.), wherein various other methods for navigation of such information is required. In other words, a numeric keypad can no longer handle the proper data input for various functionality and any navigation utilized to sift through data related to the cell phone. Personal computing devices facilitate entering information and/or navigating information by employing input devices such as, but not limited to, keyboards, keypads, touch pads, touch-screens, speakers, stylus' (e.g., wands), microphones, writing pads, roller-balls, wheels, . . . However, such input techniques are inferior in comparison to traditional input techniques utilized with a personal computer, laptop, and/or desktop PC. Based at least in part upon the growing trend of the amount of personal computing devices on the market and/or the increasing amount of storage capacity associated with such personal computing devices, improved data navigation techniques are necessary in order to provide useful devices.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate navigation through data associated with a portable computing device. A portable computing device can be, for instance, a phone, a cell phone, a smart phone, a portable digital assistant (PDA), a pager, a hand-held, a scanner, a bar code scanner, a six function device (e.g., language translator), and/or any portable computing device with a display capable of navigation and/or data selection. Moreover, the portable computing device can utilize a navigation component that allows a movement of the entire portable computing device to correspond with data navigation related to such device. In other words, the portable computing device incorporates a mouse functionality, wherein the entire portable computing device simulates a mouse input device, wherein a movement of the portable computing device can correlate with data navigation therewith.

The navigation component can utilize surface data received via an interface, wherein the surface data can be associated with the change of position related to the portable computing device in relation to a surface planar to such device. The interface can be a trackball, an optical sensor, and/or any motion detection mechanism to determine the position and/or position changes related to the entire portable computing device. The surface data can then be utilized by the navigation component to provide navigation, wherein the navigation is based at least in part upon the movement (e.g., change of position) of the entire portable computing device.

In accordance with one aspect of the claimed subject matter, the navigation component can include an optical sensor to facilitate determination of surface data and/or change of positioning related to the portable computing device. The optical sensor can utilize optical technology, wherein the sensor can determine any motion related to the entire portable computing device. Furthermore, the navigation component can include a location generator to provide a correlation between the movement of the entire portable computing device and data navigation associated therewith. The location generator can provide a mapping based at least in part upon at least one of the following: portable computing device size, display size, cursor size, distance of movement, etc.

In accordance with another aspect of the claimed subject matter, the portable computing device can further include a display that provides visualization of data and/or data navigation to a user. The display can be any suitable display associated with the portable computing device. Moreover, the portable computing device can include an input, wherein the input can facilitate selection of data during navigation. In one example, the input can be an input button and/or a wheel input. In addition, the portable computing device can include an options component, wherein a user can configure options associated with data navigation utilizing surface data (e.g., utilizing incorporated mouse functionality with the portable computing device). In another aspect of the claimed subject matter, a selector is provided wherein a user can choose a navigational technique. In one example, a user can select between a plurality of navigation techniques based at least in part upon the environment settings of the user and/or the portable computing device. In other aspects of the claimed subject matter, methods are provided that facilitate navigation of data on a display associated with a portable computing device.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates navigation related to a portable computing device.

FIG. 2 illustrates a block diagram of an exemplary system that facilitates utilizing surface data to provide navigation associated with a portable computing device.

FIG. 3 illustrates a block diagram of an exemplary system that facilitates navigation on a display within a portable computing device.

FIG. 4 illustrates a portable computing device that facilitates navigation utilizing surface data.

FIG. 5 illustrates a portable computing device that facilitates navigation utilizing surface data received by an optical sensor.

FIG. 6 illustrates a portable computing device that facilitates navigation associated with a display on the portable computing device.

FIG. 7 illustrates a block diagram of an exemplary system that facilitates navigation related to a portable computing device.

FIG. 8 illustrates an exemplary methodology for navigating on a portable computing device.

FIG. 9 illustrates an exemplary methodology that facilitates navigating on a display associated with a navigation device based at least in part upon the device change of position and surface data.

FIG. 10 illustrates an exemplary methodology for navigating on a display associated with a portable computing device utilizing surface data and allowing configuration options.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

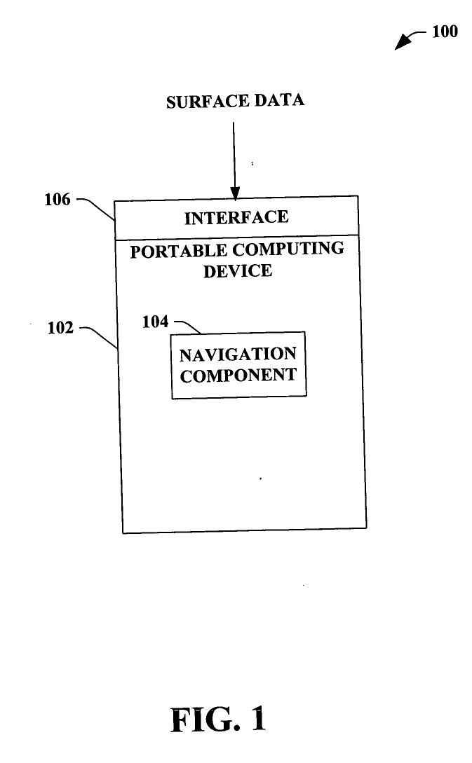

Now turning to the figures, FIG. 1 illustrates a system 100 that facilitates navigation related to a portable computing device. A portable computing device 102 can receive, via an interface 106 (discussed infra) to enhance navigation associated with the portable computing device. The portable computing device 102 can be, but is not limited to, a phone, a cell phone, a smart phone, a portable digital assistant (PDA), a pager, a hand-held, a scanner, a bar code scanner, a six function device (e.g., language translator), and/or any portable computing device with a display capable of navigation and/or data selection. For example, a cell phone can provide numerous functionalities, wherein a plurality of data can be selected, highlighted, navigated, scrolled, etc. Thus, a user can navigate through the cell phone address book, stored pictures, menus, text messages, email, etc. The portable computing device 102 can utilize the surface data such that a navigation component 104 can map such data to correlate with navigation associated with the portable computing device. The surface data can be, for instance, data related to a position, a change in positioning, and/or location of the portable computing device 102. Furthermore, the surface data can be collected by the interface 106, a track ball, an optical sensor, any motion detector, etc. In other words, the change of positioning related to the portable computing device 102 can facilitate navigation associated with the device itself, such that a user can inspect/select data therewith.

The navigation component 104 can provide the navigation of data within the portable computing device 102 based at least in part upon the surface data that relates to the change of positioning, motion, and/or location of the device. For example, a user can re-position the portable computing device 104, wherein such re-positioning can be utilized to provide navigation on, for example, a display associated with such portable computing device. In other words, the portable computing device 102 can enhance navigation and/or data selection by implementing mouse functionality, wherein the portable computing device 102 incorporates the mouse functionality within. In one example, a user can place the portable computing device 102 on a flat surface, such that any movement and/or change of positioning in a parallel axis can be mapped to movement of a cursor on a display within the portable computing device 102. For instance, a user can move the portable computing device an inch on a flat surface, wherein the navigation component 104 can utilize such surface data to map a proportional movement (e.g., change of positioning) for a cursor on a display associated with the portable computing device 102. By providing such option of utilizing the portable computing device with incorporated mouse functionality, the navigation of data associated with the portable computing device 102 is greatly enhanced.

It is to be appreciated that the navigation component 104 is incorporated into the portable computing device 102 such that the surface data that relates to the change of positioning related to the entire portable computing device 102 is utilized to provide navigation within the portable computing device. Moreover, it is to be appreciated and understood that the portable computing device 102 can implement a display, wherein the display allows the data to be visual to the user. The navigation component 104 allows the navigation of data utilizing, for instance, a cursor, wherein the movement of the cursor correlates directly and/or indirectly with the change of positioning, motion, and/or location of the portable computing device 102.

Moreover, the system 100 can include any suitable and/or necessary interface component 106, which provides various adapters, connectors, channels, communication paths, etc. to receive any surface data and utilize such data into virtually any operating, database system(s), and/or portable computing devices. In addition, the interface component 106 can provide various adapters, connectors, channels, communication paths, etc., that provide for interaction with the surface data, portable computing device 102, and/or navigation component 104.

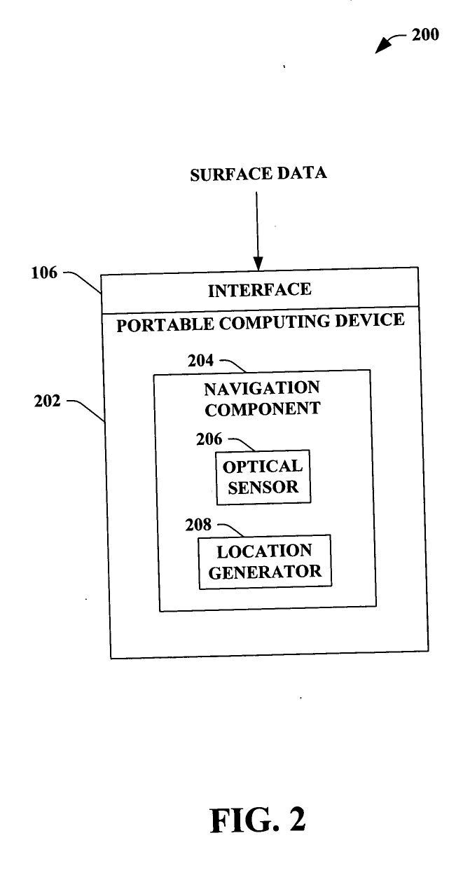

FIG. 2 illustrates a system 200 that facilitates utilizing surface data to provide navigation associated with a portable computing device. A portable computing device 202 can utilize a navigation component 204 to facilitate navigating and/or sifting through data associated therewith. The navigation component 204 can utilize surface data received via the interface 106, wherein such surface data can correspond to a change of positioning, motion, and/or location of the entire portable computing device 202. In other words, the interface 106 can receive surface data related to the change of positioning related to the portable computing device 202, wherein the navigation component 204 can utilize such collection of data to provide navigation therewith. It is to be appreciated and understood that the computing device can be, for instance, a phone, a cell phone, a smart phone, a portable digital assistant (PDA), a pager, a hand-held, a scanner, a bar code scanner, a six function device (e.g., language translator), a portable gaming device, and/or any portable computing device with a display capable of navigation and/or data selection. It is to be appreciated that the portable computing device 202, the navigation component 204, and surface data can be substantially similar to devices, components, and/or data described previously.

The navigation component 204 can include an optical sensor 206 that utilizes optical technology in order to provide the detection and implementation of surface data to be utilized to navigate within the portable computing device 202. The optical sensor 206 can be located on the back portion of the portable computing device 202 such that the portable computing device 202 can be placed on a surface allowing data to be collected. For instance, a PDA can have such described mouse functionality incorporated therewith, wherein the user can select such surface data navigation and the PDA movement (e.g., motion, change of position) detected by the optical sensor 206 can correlate to the cursor navigation. The user can place the PDA on a surface, and move the PDA such that any movement and/or re-positioning (e.g., detected by the optical sensor 206) relates to the movement of the cursor associated with a display on the PDA. Although the portable computing device 202 includes an optical sensor 206, it is to be appreciated that the navigation component 204 can utilize any movement, motion, position, and/or location detection technique such as, but is not limited to, track ball, laser, wireless optical sensor, and/or any suitable technique.

The navigation component 204 can further include a location generator 208 that provides correlation between surface data collected any mapping to allow navigation associated with the portable computing device 202. The location generator 208 can receive raw surface data and determine the correlation of movement, re-positioning, and/or location related to the portable computing device 202 with the cursor movement, re-positioning, and/or location on a display associated therewith. For example, the correlation can be based at least in part upon the portable computing device 202 size and/or dimensions, display size and/or dimensions, cursor size and/or dimensions, user sensitivity options, and/or display settings (e.g., font, pixels, video capability, color, etc.). In one example, the optical sensor 206 can determine surface data and/or change in surface data, wherein the location generator 208 can map such movement and/or re-positioning to the display associated with the portable computing device 202.

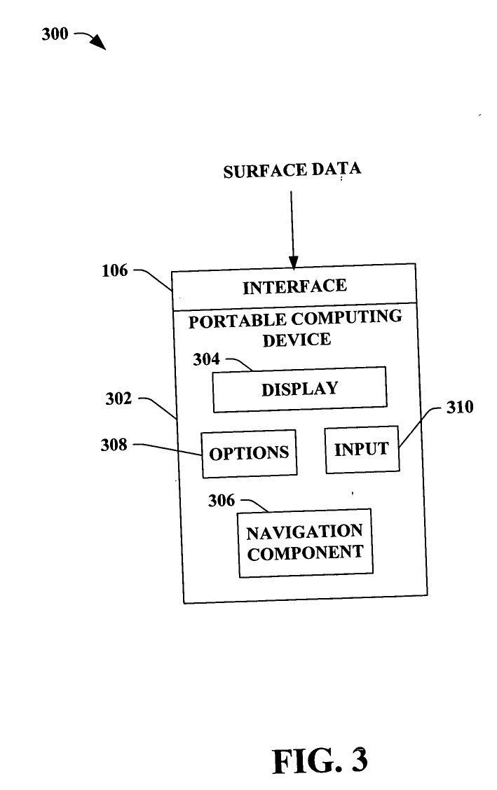

FIG. 3 illustrates a system 300 that facilitates navigation on a display within a portable computing device. Surface data can be collected by the interface 106, wherein such data can be utilized by a navigation component 306 to provide navigation on a display 304 associated with a portable computing device 302. The surface data can be change of positioning data, motion detection data, and/or location data that relates to the position of the entire portable computing device 302, wherein such movements can correlate to navigation on the display 304. For instance, the display 304 can include a cursor, pointer, selector, etc., wherein a user can utilize the incorporated mouse functionality (e.g., implemented by surface data and the navigation component 306) to navigate, move, and/or re-position the cursor. The display 304 can be any suitable component to view data associated with the portable computing device 302 such as, but not limited to, an LCD, monitor, dot matrix, etc. It is to be appreciated that the portable computing device 302, the navigation component 304, and surface data can be substantially similar to devices, components, and/or data described above.

The portable computing device 302 can include an options component 308 (herein referred to as “options 308”). The options 308 can provide configuration settings related to the navigation component 306. For example, the options 308 can provide movement correlation settings, cursor settings, cursor speed, sensitivity, etc. In another example, the options 308 can allow the user to designate functionality to various inputs (discussed infra). Moreover, the options 308 can allow the user to specify the ability to select the type of navigation associated with the portable computing device 302. It is to be appreciated that the options 308 can provide a plurality of configuration settings and the above examples are not to be limiting on the claimed subject matter.

The portable computing device 302 can further include an input 310 that allows the user to provide input related to the navigation of data. The input 310 can be any button, wheel, etc. that allows a user to select data on the display 304. For instance, the user can select a menu topic utilizing the portable computing device 302 to direct the cursor to the menu topic, wherein the input 310 can be implemented to select the topic to provide further display of data. It is to be appreciated and understood that the input 310 can be any suitable technique and/or mechanism that allows a user to select data related to the navigation within the portable computing device 302.

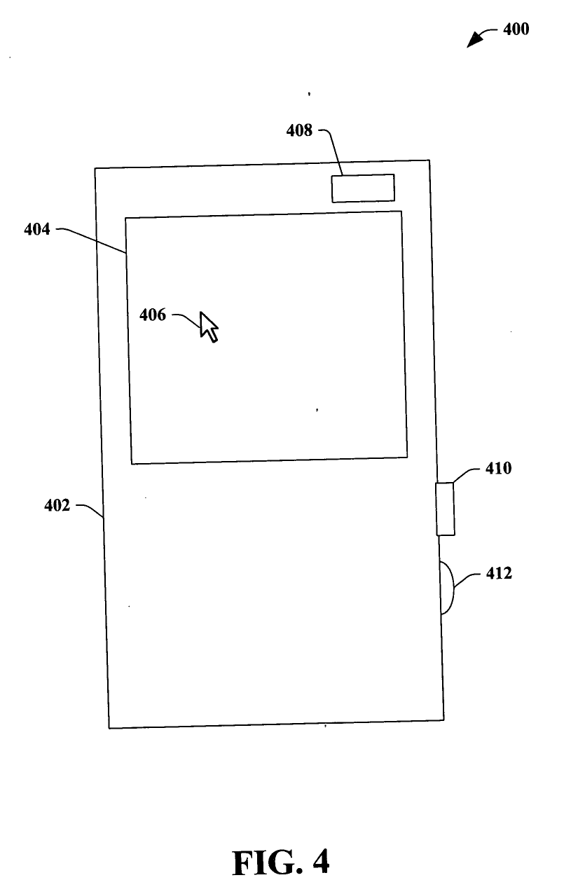

FIG. 4 illustrates a system 400 that facilitates navigation utilizing surface data. A front portion of a portable computing device 402 can include a display 404 and a cursor 406 that allows the navigation of data associated therewith. The portable computing device 402 is one example, and it is to be appreciated that the claimed subject matter is not so limited. The portable computing device 402 can be substantially similar to the portable computing device described in pervious figures. For instance, the portable computing device 402 can be a phone, a cell phone, a smart phone, a portable digital assistant (PDA), a pager, a hand-held, a scanner, a bar code scanner, a six function device (e.g., language translator), a portable gaming device, and/or any portable computing device with a display capable of navigation and/or data selection.

The portable computing device 402 can include a selector 408 that allows the selection of the navigation technique. For instance, the user can implement a stylus to navigate within a factory, but utilize the selector 408 to navigate data when the user has access to a surface such as a desk in an office. Furthermore, the portable computing device 402 can include an input button 410. The input button 410 can allow the selection of data during navigation. For example, the cursor 406 can be positioned to a portion of data that a user would like to select by positioning and/or moving the portable computing device 402 to correspond to the desired cursor location. Upon the desired cursor location, the input button 410 can be utilized to select such data. Possible selection options for the input 410 can include, but are not limited to, a single click, a double click, a click and hold, etc. The portable computing device 402 can also include a wheel input 412 that allows a scrolling navigation on data on the display 404. For example, the wheel input 412 can be utilized to scroll up and/or down a page of data during a navigation associated with the portable computing device 402.

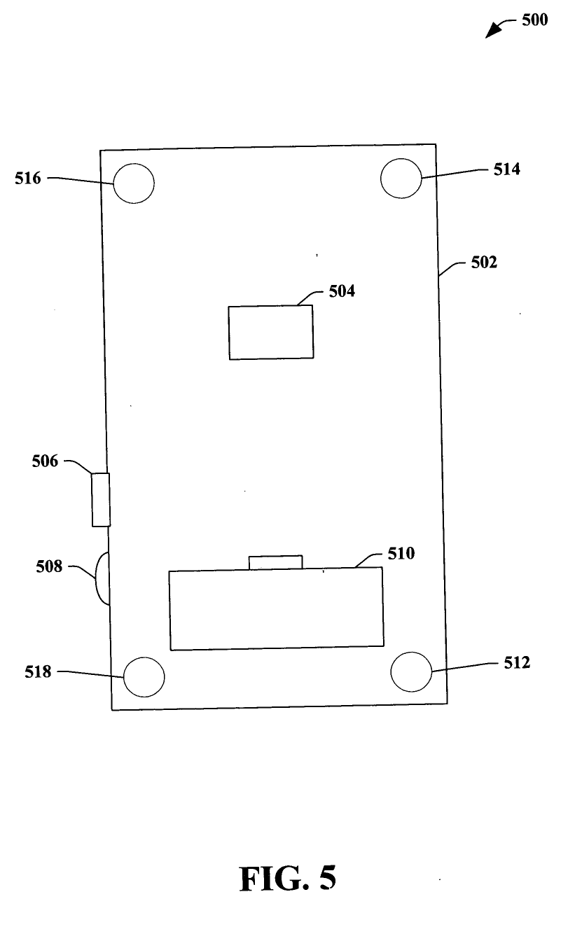

FIG. 5 illustrates a system 500 that facilitates navigation utilizing surface data received by an optical sensor. A back portion of a portable computing device 502 can include an interface 504 that receives surface data to determine a change of positioning related to the entire portable computing device 502. The interface 504 can be, for instance, a trackball, an optical sensor, etc. The portable computing device 502 is one example, and it is to be appreciated that the claimed subject matter is not so limited. For instance, the portable computing device 502 can be moved in the X+ direction, wherein a cursor, for example, can be re-positioned in the X+ direction on a display to facilitate navigation associated with data. Furthermore, the back portion of the portable computing device 502 can include a number of pads (herein referred to pads) 512, 514, 516, and 518. The pads can be, for instance, Teflon pads, to aid in the surface parallel mobility of the portable computing device 502. As depicted in FIG. 4, the portable computing device 502 can utilize an input button 506 and a wheel input 508 (discussed supra). The portable computing device 502 can also include an optional battery compartment 510, wherein any power supply and/or batter can be stored and/or be accessible for replacement and/or charge.

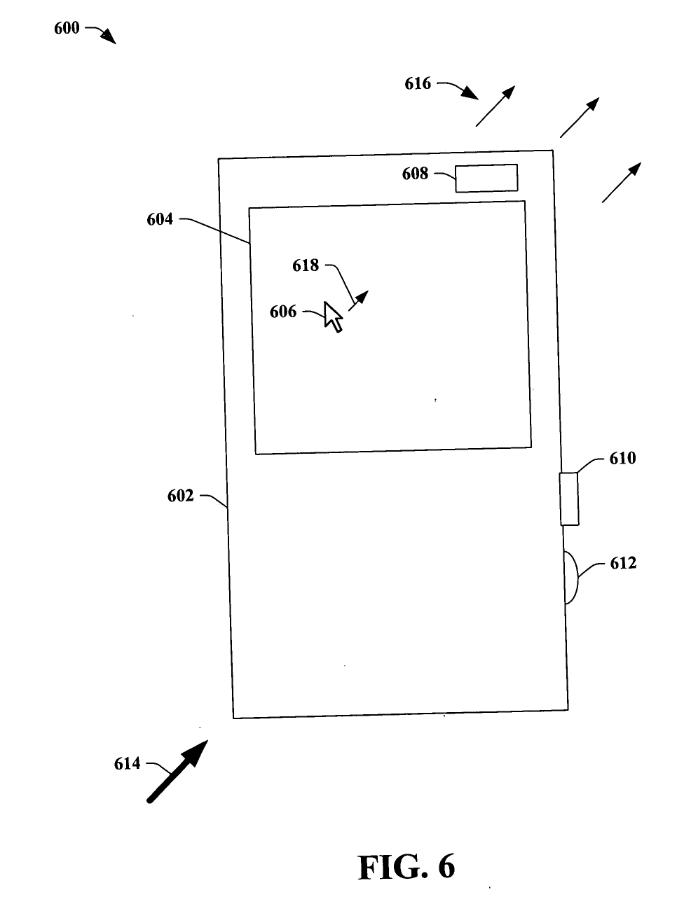

FIG. 6 illustrates a system 600 that facilitates navigation associated with a display on the portable computing device. A portable computing device 602 can include a display 604 to provide visuals associated with data related to the portable computing device 602. In order to navigate such data, the device can include a cursor 606, wherein such data can be selected, highlighted, manipulated, etc. The portable computing device 602 can further include a selector 608 to select a particular navigational function. For example, the selector 608 can allow a user to select between a stylus pen, a touch screen, and an incorporated mouse function utilizing the entire portable computing device 602 and surface data as a navigational aid. As stated above, the portable computing device 602 can also include an input button 610 and a wheel input 612 to facilitate inputting and/or selecting data.

A user can provide a movement and/or force parallel to the surface on which the portable computing device 602 rests upon. A first force 614, can be initiated by a user to provide a navigation related to the display 604. The first force 614 can cause the entire portable computing device 602 to move in the direction depicted by the arrows 616. The first force 614 can be a distance that can be proportional to a distance 618, wherein the cursor 606 is re-positioned. In other words, the distance associated with the entire portable computing device 602 can be utilized to provide a re-positioning of the cursor 606 on the display 604 allowing navigation of data with ease. It is to be appreciated that the direction of movement for the entire portable computing device 602 can be in any direction parallel to the surface on which the device is planar and any examples of a particular direction is not to be limiting on the claimed subject matter.

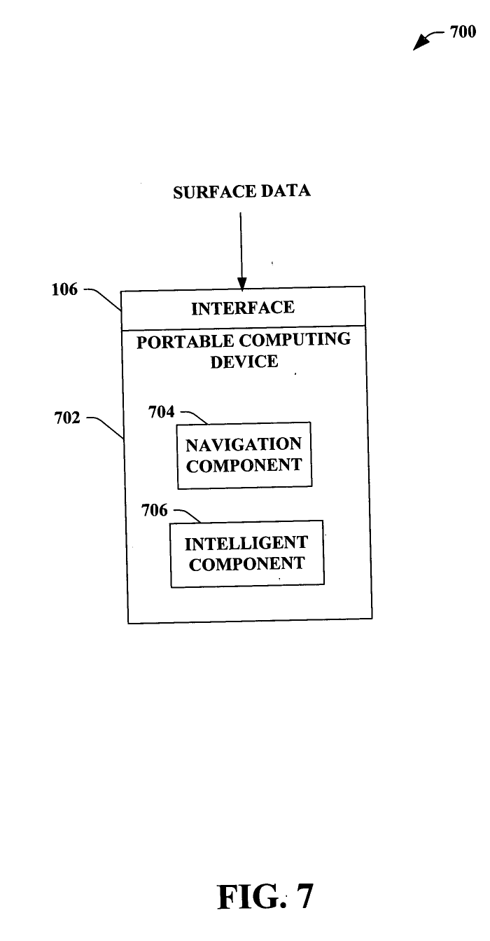

FIG. 7 illustrates a system 700 that employs intelligence to facilitate navigation related to a portable computing device. The system 700 can include a portable computing device 702 and a navigation component 704 that can all be substantially similar to respective devices and components described in previous figures. The system 700 further includes an intelligent component 706. The intelligent component 706 can be utilized by the portable computing device 702 to facilitate utilizing the incorporated mouse functionality with navigation. For instance, the settings and/or configurations can be inferred based at least in part upon user profiles and/or history.

It is to be understood that the intelligent component 706 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

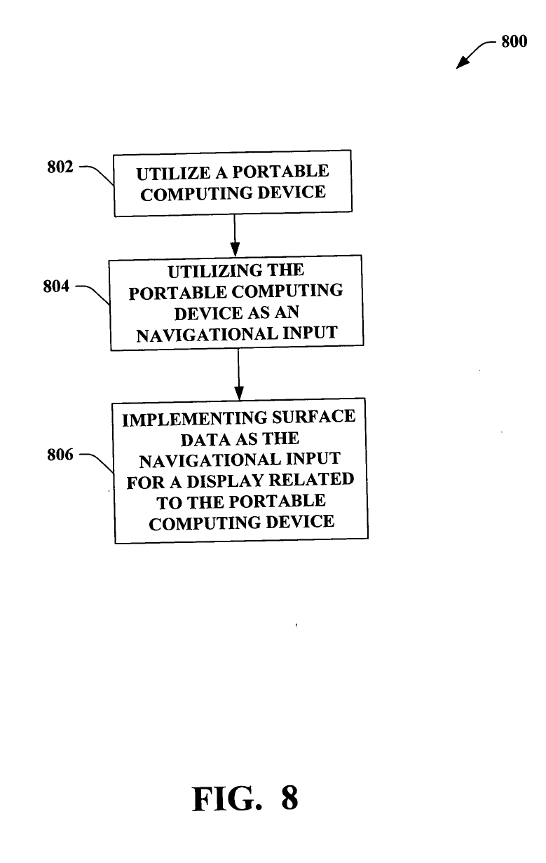

FIGS. 8-10 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events.

FIG. 8 illustrates a methodology 800 for navigating on a portable computing device. At reference numeral 802, a portable computing device can be utilized. It is to be appreciated and understood that the computing device can be, for instance, a phone, a cell phone, a smart phone, a portable digital assistant (PDA), a pager, a hand-held, a scanner, a bar code scanner, a six function device (e.g., language translator), a portable gaming device, and/or any portable computing device with a display capable of navigation and/or data selection. For example, a cell phone can provide various menus, screens, and/or functionality including various data, wherein such data can be navigated by a user. Thus, a user can navigate through menus, screens, address books, and/or any other suitable data associated therewith. At reference numeral 804, the portable computing device as a navigational input for navigating through data associated therewith. At reference numeral 806, surface data can be implemented as the navigational input for a display related to the portable computing device. The surface data can be, for instance, data related to a change of positioning related to the portable computing device, motion, position, and/or location of the portable computing device. In addition, the surface data can relate to any surface on which is planar to the portable computing device. Furthermore, the surface data can be collected by an interface, a track ball, an optical sensor, any motion detector, etc. For instance, the portable computing device can receive surface data that determines a change of positioning and/or location related to the entire portable computing device. Such surface data can be utilized to correspond to the location of the entire portable computing device with the re-positioning of a cursor related to the display on such portable computing device. In other words, a movement of the portable computing device can relate to the change of positioning of navigation within the portable computing device.

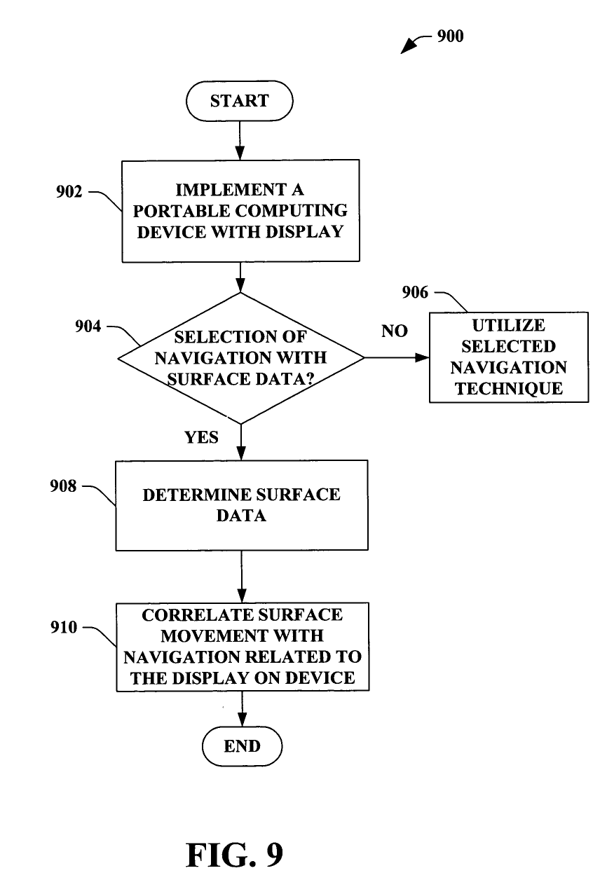

FIG. 9 illustrates a methodology 900 that facilitates navigating on a display associated with a navigation device based at least in part upon the device change of position and surface data. At reference numeral 902, a portable computing device with a display can be implemented. The computing device can be, for instance, a phone, a cell phone, a smart phone, a portable digital assistant (PDA), a pager, a hand-held, a scanner, a bar code scanner, a six function device (e.g., language translator), a portable gaming device, and/or any portable computing device with a display capable of navigation and/or data selection.

At reference numeral 904, a determination is made whether navigation utilizing surface data (e.g., utilizing the incorporated mouse function and/or utilizing the entire portable computing device as a mouse) is to be selected. The determination of the navigation technique can be based at least in part upon a selector button and/or option associated with the portable computing device. If such navigation technique is not selected, at reference numeral 906, the portable computing device is utilized with the selected navigational technique. If the surface data navigation is utilized, the method continues at 908. At reference numeral 908, surface data can be determined. For instance, the surface data can be determined by utilizing a trackball, an optical sensor, and/or any other suitable motion detection. At reference numeral 910, the surface data and/or movement can be correlated with navigation related to the display on the portable computing device. Thus, a movement of the entire portable computing device can correlate to the re-positioning and/or navigation associated with a cursor on the portable computing device's display.

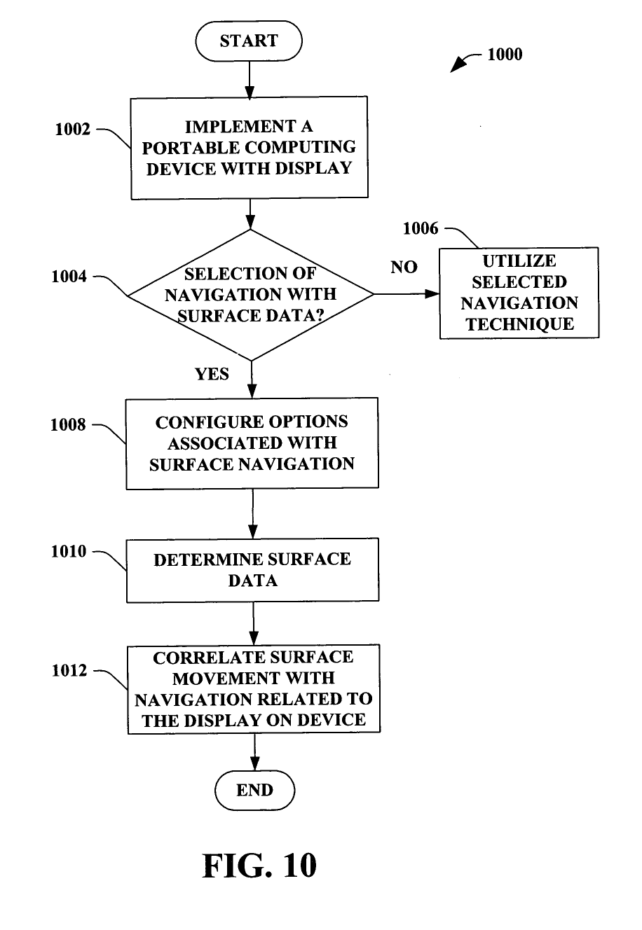

FIG. 10 illustrates a methodology 1000 for navigating on a display associated with a portable computing device utilizing surface data and allowing configuration options. At reference numeral 1002, a portable computing device can be implemented. It is to be appreciated and understood that the portable computing device can be, for instance, a phone, a cell phone, a smart phone, a portable digital assistant (PDA), a pager, a hand-held, a scanner, a bar code scanner, a six function device (e.g., language translator), a portable gaming device, and/or any portable computing device with a display capable of navigation and/or data selection.

At reference numeral 1004, a determination is made whether the user selects navigation with surface data. If the user does not select to navigate data utilizing surface data, the method continues at reference numeral 1006, wherein the selected navigation technique is implemented. If the user selects navigation with surface data, the method continues with reference numeral 1008, where options associated with the surface navigation can be configured. For example, the options can provide movement correlation settings, cursor settings, cursor speed, sensitivity, etc. In another example, the options can allow the user to designate functionality to various inputs (discussed infra). Moreover, the options can allow the user to specify the ability to select the type of navigation associated with the portable computing device. It is to be appreciated that the options can provide a plurality of configuration settings and the above examples are not to be limiting on the claimed subject matter.

At reference numeral 1010, the surface data can be determined. For instance, the surface data can be determined by utilizing a trackball, an optical sensor, and/or any other suitable motion detection. At reference numeral 1012, the surface data and/or movement can be correlated with navigation related to the display on the portable computing device. Thus, a movement, change of positioning, and/or motion to the entire portable computing device can correspond to the re-positioning and/or movement of a cursor utilized for navigation of data therewith.

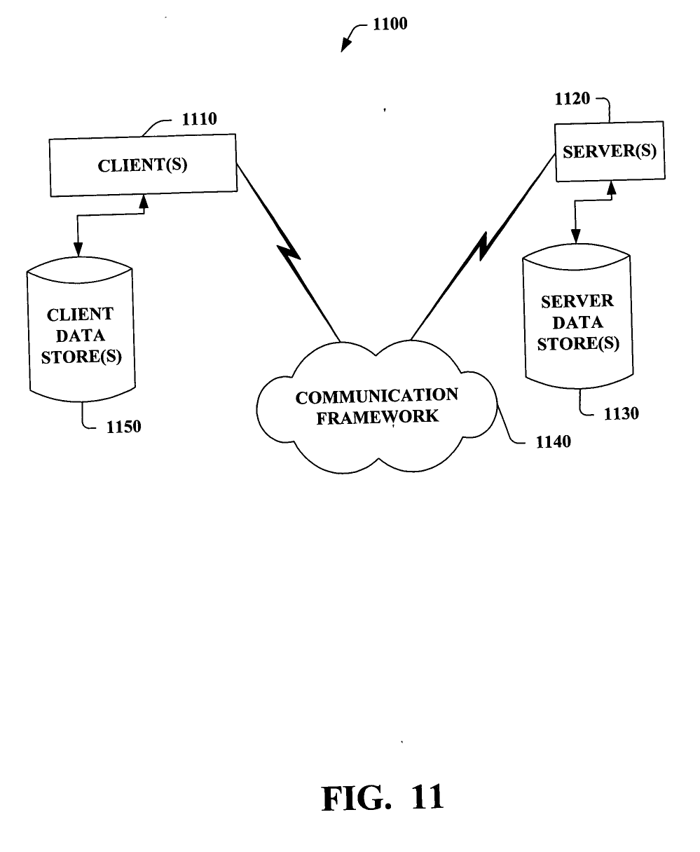

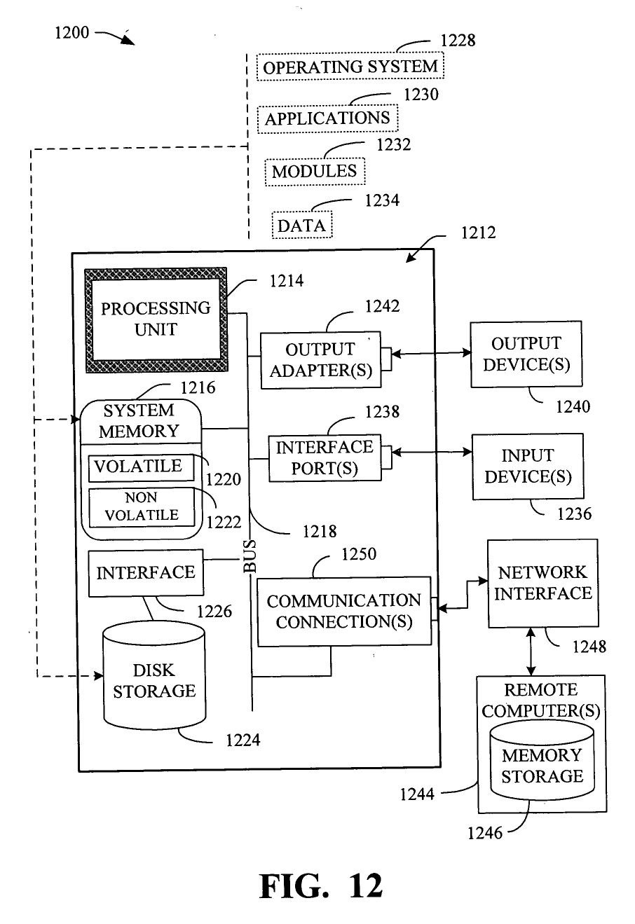

In order to provide additional context for implementing various aspects of the claimed subject matter, FIGS. 11-12 and the following discussion is intended to provide a brief, general description of a suitable computing environment in which the various aspects of the subject innovation may be implemented. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates enhancing navigation associated with a portable computing device, comprising:
an interface that receives surface data based on a change of positioning related to the portable device; and
a navigation component that implements navigation within the portable computing device based at least in part upon surface data.

2. The system of claim 1, the portable computing device including a display to view data associated therewith.

3. The system of claim 1, the portable computing device including a cursor to navigate data related to the portable computing device.

4. The system of claim 1, the portable computing device is at least one of the following: a phone; a cell phone; a smart phone; a portable digital assistant (PDA); a pager; a hand-held; a scanner; a bar code scanner; a six function device; a language translator; a portable gaming device; a portable computing device with a display capable of data navigation.

5. The system of claim 1, the portable computing device further comprising an interface to receive surface data by detection motion of the portable computing device.

6. The system of claim 5, the interface is at least one of an optical sensor and a trackball.

7. The system of claim 1, the portable computing device further comprising a location generator that provides correlation between surface data collected and navigation associated with the portable computing device.

8. The system of claim 1, the portable computing device further comprising an options component that allows the configuration of the navigation component.

9. The system of claim 8, the configuration is at least one of the following: a movement correlation setting; a cursor setting; a cursor speed; a cursor sensitivity; and a navigation technique.

10. The system of claim 1, the portable computing device further comprising an input component.

11. The system of claim 10, the input component is at least one of an input button on the portable computing device and a wheel input on the portable computing device.

12. The system of claim 1, the portable computing device further comprising a selector that provides the selection of the navigation technique.

13. The system of claim 1, the portable computing device further comprising at least one pad on a bottom portion of the portable computing device.

14. The system of claim 1, the portable computing device further comprising at least one of a trackball and an optical sensor on a bottom portion of the portable computing device.

15. The system of claim 1, the surface data is collected from any surface planar to the portable computing device.

16. A computer readable medium having stored thereon the components of the system of claim 1.

17. A computer-implemented method that facilitates providing navigation to a portable computing device, comprising:
utilizing a portable computing device;
utilizing the portable computing device location as a navigational input; and
implementing surface data as the navigational input to correlate navigating on a display related the portable computing device.

18. The method of claim 17, further comprising:
determining a selected navigational technique; and
determining surface data utilizing at least one of a trackball and an optical sensor.

19. The method of claim 17, further comprising:
correlating a surface movement of the portable computing device with navigation related to the display; and
configuring options associated with surface data navigation.

20. A computer-implemented system that facilitates implementing navigation related to a portable computing device, comprising:
means for receiving surface data based on a change of positioning related to the portable device; and
means for implementing navigation within the portable computing device based at least in part upon surface data.
